(19) United States
(12) Patent Application Publication
(10) Pub. No.: US 2022/0002556 A1
(43) Pub. Date: Jan. 6, 2022

(54) Carbon Black for Improved Automotive Anti-Vibration Rubber Compound Performance

(71) Applicant: BIRLA CARBON U.S.A., INC., MARIETTA, GA (US)

(72) Inventor: LEWIS B TUNNICLIFFE, MARIETTA, GA (US)

(21) Appl. No.: 17/280,465

(22) PCT Filed: Sep. 26, 2019
(86) PCT No.: PCT/US19/53115

§ 371 Date: Mar. 26, 2021

Related U.S. Application Data
(60) Provisional application No. 62/736,494, filed on Sep. 26, 2018.
(60) Provisional application No. 62/736,634, filed on Sep. 26, 2018.

(51) Int. Cl. C09C 1/50; C08L 21/00; F16F 1/38; F16F 15/12

(52) U.S. Cl. CPC C09C 1/50; C08L 21/00; F16F 1/38; C08K 2201/006; C01P 2006/12; C01P 2006/19; F16F 15/12

(57) ABSTRACT

Carbon black for use in anti-vibration compounds and components, anti-vibration bushings and engine mounts, together with such anti-vibration compounds and components and methods for the manufacture and use thereof.

### CROSS-REFERENCE TO RELATED APPLICATIONS

This application claims the benefit of U.S. Provisional Application No. 62/736,494, filed Sep. 26, 2018, and U.S. Provisional Application No. 62/736,634, filed Sep. 26, 2018, which are both incorporated herein by reference in their entirety.

### TECHNICAL FIELD

The present disclosure relates to carbon black that can be useful in anti-vibration composites, such as, for example, carbon filled rubber anti-vibration components. The disclosure also provides the anti-vibration components and methods for the manufacture and use thereof.

### TECHNICAL BACKGROUND

The primary purpose of vibration isolation devices is to detune the resonance frequency of the object to be isolated from the incident or environmental vibration. This isolation is typically achieved using rubber mounts having a tailored geometry and tailored static and dynamic mechanical properties. In many cases, natural rubber (NR) is the rubber of choice due to its inherent elasticity, low hysteresis, and its excellent resistance to fatigue crack growth.

To minimize the resonance frequency of a system, such as, for example, a mount for isolating engine vibrations from an automotive chassis, the rubber compound should have minimal dynamic stiffness (K_{d}) and hysteresis. In addition, the rubber compound needs to exhibit appropriate static stiffness (Kₛ), minimal creep behavior, and maximized fatigue life.

In practice, carbon black is used to achieve the desired static stiffness and fatigue resistance of rubber compounds for vibration isolation devices; however, carbon black materials tend to network in rubber compounds and increase the dynamic stiffness and hysteresis of the compound. A typical carbon black based reinforcement system in the vibration isolation industry utilizes a blend of thermal carbon black and furnace carbon black. In such systems, an ASTM N990 grade thermal carbon black is frequently the major component, present in a blend with a reinforcing furnace carbon black, such as, for example, an ASTM N774 or N660 grade furnace carbon black. Thermal carbon blacks exhibit large particle sizes and low structure, which can impart low dynamic stiffness and hysteresis to a resulting rubber compound, but these thermal carbon blacks impart only limited resistance to fatigue crack growth. Thermal carbon blacks are also limited in their global supply.

Accordingly, there is a need for improved vibration isolation compounds and reinforcing materials for the use in the same. These needs and other needs are satisfied by the compositions and methods of the present disclosure.

### SUMMARY

In accordance with the purpose(s) of the invention, as embodied and broadly described herein, this disclosure, in one aspect, relates to carbon black, to anti-vibration compounds and components, and methods for the manufacture and use thereof.

Disclosed herein is a rubber compound comprising a furnace carbon black having a nitrogen surface area of from about 15 m²/g to about 30 m²/g, and an oil absorption number of from about 35 ml/100 g to about 135 ml/100 g.

Also disclosed herein is a vibration isolation device comprising a rubber compound disclosed herein.

Also disclosed herein is a rubber article comprising a furnace carbon black having a nitrogen surface area of from about 55 m²/g to about 65 m²/g, and an oil absorption number of from about 145 ml/100 g to about 165 ml/100 g.

Also disclosed herein is a vibration isolation device comprising a rubber article disclosed herein.

Additional advantages will be set forth in part in the description which follows, and in part will be obvious from the description, or can be learned by practice of the aspects described below. The advantages described below will be realized and attained by means of the chemical compositions, methods, and combinations thereof particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates the measurement of a spring rate constant for a rubber compound, in accordance with various aspects of the present disclosure.

FIGS. 2A and 2B illustrate load and test conditions for the measurement of a spring rate constant for a rubber compound, in accordance with various aspects of the present disclosure.

FIG. 3 illustrates fatigue life vs. tensile strain for a control compound comprising a blend of thermal carbon black and furnace carbon black, and for three rubber compounds comprising inventive carbon blacks, in accordance with various aspects of the present disclosure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

As used herein, unless specifically described otherwise, “phr” is intended to refer to parts per hundred of rubber, as commonly understood and used in the rubber industry.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless indicated otherwise, parts are parts by weight, temperature is in ° C. or is at ambient temperature, and pressure is at or near atmospheric.

In one aspect, the carbon black materials of the present disclosure comprise furnace carbon blacks.

### Automotive Bushing Compounds

Materials used in automotive bushing compounds typically see high loading conditions. As a result, these compounds are typically designed to have maximum fatigue life under complex loading conditions, balanced with low spring rates (K_{d}/Kₛ) for vibration isolation performance.

Conventional automotive bushing compounds utilized ASTM N300 series carbon blacks to provide reasonable fatigue performance and static stiffness in natural rubber compounds; however the use of these N300 series carbon blacks can be detrimental to the spring rate and thus, to the vibration isolation performance of the resulting bushing compound.

In one aspect, the present disclosure provides carbon blacks for use in improved bushing compounds. In one aspect, such a carbon black can comprise a BC2123 grade carbon black, available from Birla Carbon U.S.A., Inc. In various aspects, the inventive carbon black can be utilized to replace all or a portion of a conventional carbon black in a bushing compound. In another aspect, this disclosure provides an improved anti-vibration bushing compound comprising one or more of the carbon blacks described herein. In various aspects, an anti-vibration compound comprising such a carbon black can exhibit significantly reduced spring rate with equivalent compound durability at equal compound hardness, as compared to a conventional bushing compound.

Carbon blacks identified with Nxxx, such as N330, N990, and N660 are intended to refer to ASTM grades of carbon black. Carbon blacks identified with BCxxxx are intended to refer to carbon black grades produced by Birla Carbon U.S.A., Inc. Test methods are those established by ASTM or commonly accepted and utilized in the carbon black industry. OAN refers to oil absorption number (ASTM D2414) and is intended to provide an indication of the structure, or aggregate size, of a carbon black grade. COAN refers to the oil absorption number of a compressed carbon black sample (ASTM D3493). In some aspects, the difference between the OAN and COAN of a carbon black sample can provide an indication of the stability of the structure of the carbon black. NSA refers to nitrogen surface area (ASTM D6556) and is a measure of the total surface area of a carbon black sample accessible to nitrogen, including porosity, based on B.E.T. theory. STSA refers to the statistical thickness surface area or external surface area (ASTM D6556) of a carbon black sample that is accessible to rubber. Iodine adsorption (ASTM D1510) relates to the surface area of a carbon black sample is generally agrees with NSA values, although the presence of volatiles, surface porosity, or extractables can influence the iodine number. Aging of a carbon black sample can also influence the iodine number.

TABLE 1
Colloidal Properties of Furnace Carbon Blacks

| | Comparative N330 | Inventive CB1 |
|---|---|---|
| OAN (ml/100 g) | 102 | 155 |
| COAN (ml/100 g) | 88 | 100 |
| NSA (m²/g) | 78 | 60 |
| STSA (m²/g) | 75 | 60 |
| Iodine (mg/g) | 82 | 60 |

In one aspect, the carbon black comprises a furnace carbon black. In another aspect, the carbon black has an OAN of from about 145 ml/100 g to about 165 ml/100 g, from about 140 ml/100 g to about 170 ml/100 g, from about 150 ml/100 g to about 160 ml/100 g, or from about 152 ml/100 g to about 158 ml/100 g. In various aspects, the carbon black has an OAN of about 150, 151, 152, 153, 154, 155, 156, 157, 158, 159, or 160 ml/100 g.

In another aspect, the carbon black has a COAN of from about 85 ml/100 g to about 115 ml/100 g, or from about 80 ml/100 g to about 120 ml/100 g, from about 90 ml/100 g to about 110 ml/100 g, from about 95 ml/100 g to about 105 ml/100 g, or from about 97 ml/100 g to about 103 ml/100 g. In various aspects, the carbon black has a COAN of about 95, 96, 97, 98, 99, 100, 101, 102, 103, 104, or 105 ml/100 g.

In another aspect, the carbon black has an NSA of from about 40 m²/g to about 80 m²/g, or from about 45 m²/g to about 75 m²/g, from about 50 m²/g to about 70 m²/g, from about 55 m²/g to about 65 m²/g, or from about 57 m²/g to about 63 m²/g. In various aspects, the carbon black has an NSA of about 55, 56, 57, 58, 59, 60, 61, 62, 63, 64, or 65 m²/g.

In another aspect, the carbon black has an STSA of from about 40 m²/g to about 80 m²/g, or from about 45 m²/g to about 75 m²/g, from about 50 m²/g to about 70 m²/g, from about 55 m²/g to about 65 m²/g, or from about 57 m²/g to about 63 m²/g. In various aspects, the carbon black has an STSA of about 55, 56, 57, 58, 59, 60, 61, 62, 63, 64, or 65 m²/g.

In another aspect, the carbon black has an Iodine number of from about 40 mg/g to about 80 mg/g, or from about 45 mg/g to about 75 mg/g, from about 50 mg/g to about 70 mg/g, from about 55 mg/g to about 65 mg/g, or from about 57 mg/g to about 63 mg/g. In various aspects, the carbon black has an Iodine number of about 55, 56, 57, 58, 59, 60, 61, 62, 63, 64, or 65 mg/g.

In one aspect, the carbon black has one or more of: an OAN of from about 145 ml/100 g to about 165 ml/100 g, from about 150 ml/100 g to about 160 ml/100 g, or from about 152 ml/100 g to about 158 ml/100 g; a COAN of from about 90 ml/100 g to about 110 ml/100 g, from about 95 ml/100 g to about 105 ml/100 g, or from about 97 ml/100 g to about 103 ml/100 g; an NSA of from about 50 m²/g to about 70 m²/g, from about 55 m²/g to about 65 m²/g, or from 57.5 m²/g about 63 m²/g; an STSA of from about 50 m²/g to about 70 m²/g, from about 55 m²/g to about 65 m²/g, or from about 57 m²/g to about 63 m²/g; and an iodine number of from about 50 mg/g to about 70 mg/g, from about 55 mg/g to about 65 mg/g, or from about 57 mg/g to about 63 mg/g. In another aspect, the carbon black has two or more of the above properties. In other aspects, the carbon black has three, four, or five of the above properties.

In a specific aspect, the carbon black has an OAN of about 155 ml/100 g, a COAN of about 100 ml/100 g, an NSA of about 60 m²/g, an STSA of about 60 m²/g, and an Iodine number of about 60 mg/g. Such a carbon black can be utilized as a replacement for any N300 series carbon black in a bushing compound. It should be understood that due to differences in colloidal properties of the respective carbon blacks, the loading of a given carbon black may need to be adjusted in a particular compound.

For example, in a conventional rubber bushing formulation comprising 100 phr of natural rubber, 5 phr zinc oxide, 2 phr stearic acid, 5 phr of TDAE oil (treated distillate aromatic extract), 3 phr of 6PPD (N′-phenyl-p-phenylenediamine), 2 phr of an anti-ozonant wax, 2.1 phr OBS (organic based stabilizer; an accelerator; such as, for example, N-oxydiethylene-2-benzothiazolesulfenamide), 0.25 phr sulfur, and 1 phr TMTD (tetramethylthiuram disulfide), approximately 50 phr of a conventional ASTM N330 grade carbon black can be used to achieve an acceptable balance of mechanical properties.

In an inventive aspect for a rubber bushing formulation, 100 phr of natural rubber, 5 phr zinc oxide, 2 phr stearic acid, 5 phr of TDAE oil (treated distillate aromatic extract), 3 phr of 6PPD (N′-phenyl-p-phenylenediamine), 2 phr of an anti-ozonant wax, 2.1 phr OBS (organic based stabilizer; an accelerator; such as, for example, N-oxydiethylene-2-benzothiazolesulfenamide), 0.25 phr sulfur, and 1 phr TMTD (tetramethylthiuram disulfide), approximately 40 to 50 phr, for example, approximately 44, 45, 46, or 46.3 phr of a carbon black as described above can be utilized to achieve an optimal balance of mechanical properties. The materials described above and in other places in this disclosure are commercially available, and one of skill in the art, in possession of this disclosure, would readily be able to prepare formulations using the inventive carbon blacks for an intended application.

In an exemplary aspect, where a conventional carbon black having a COAN of 74 ml/100 g and an STSA of 34 m²/g is replaced with an inventive carbon black having a COAN of 80 ml/100 g and an STSA of 28 m²/g, the loading of the respective carbon blacks can be adjusted from about 15 phr to about 14.4 phr.

It should be understood that the present invention is not intended to be limited to NR compositions and can include all elastomers and blends thereof that are conventionally used in anti-vibration or other carbon black filled rubber compositions, such as, for example, NR, BR, SBR, NR/BR blends, nitrile rubbers, and blends thereof. In another aspect, the formulations can also have various ratios of other components, such as sulphur, accelerators, anti-oxidants, extenders, etc.

Testing data for the compounds referenced above is detailed in Table 2, below. Test methods refer to ASTM methods or to those commonly used in the carbon black and rubber industries. Various tests can be performed on the resulting rubber compounds, including dispersion measurements via IFM, for example, with ASTM D2663, method D; Shore A Hardness (ASTM D2240), Mooney Viscosity (ASTM D1646), Stress-Strain/Tensile Strength (ASTM D412), Tear strength (ASTM D624), Fatigue Life (ASTM D4482), and Fatigue Crack Growth (Birla Carbon internal method LSX-yz). One of skill in the art can readily determine specific tests and test conditions for evaluating the mechanical properties Both formulations utilized Inventive CB1, at a loading of 46.3 phr in Test A and a loading of 44 phr in Test B.

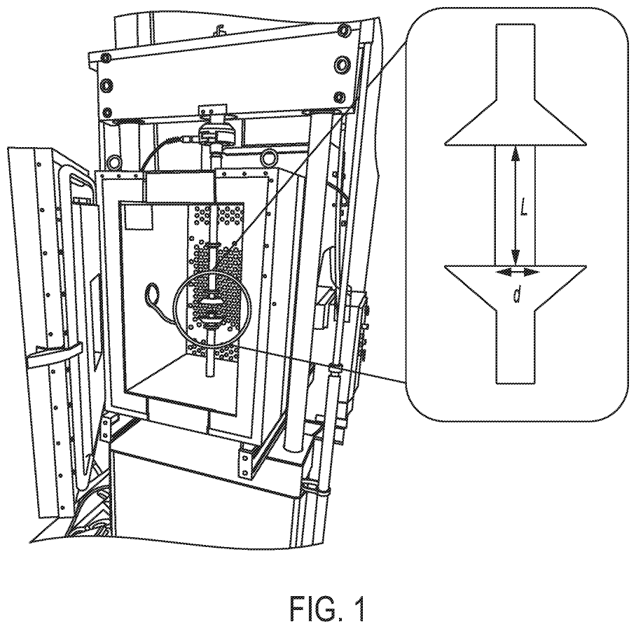

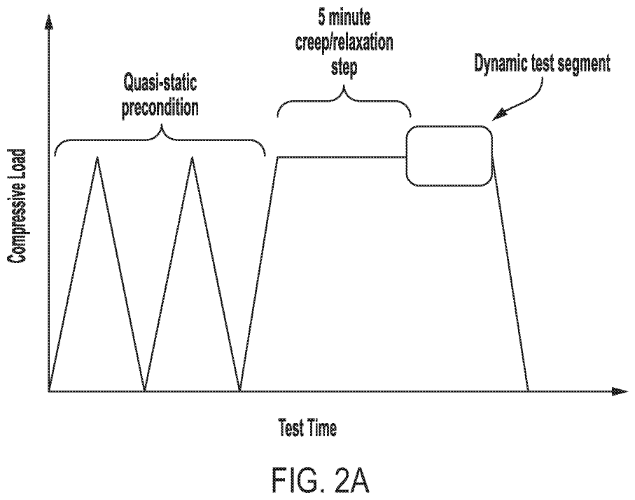

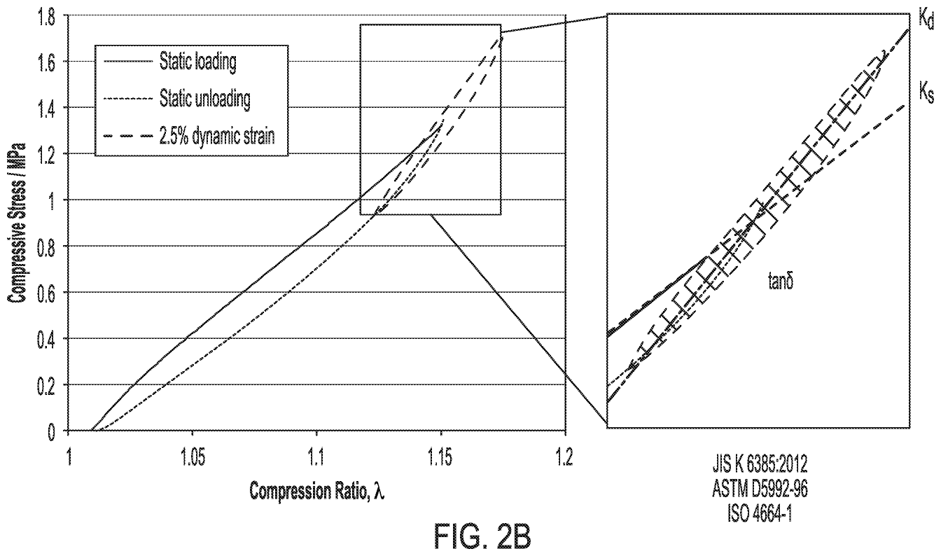

Spring rate values, as used herein, were determined according to JIS K 6385:2012, which is hereby incorporated by reference in its entirety, using the following test conditions: load controlled quasi-static deflection to 100 N; pre-cycle ×2 at ˜2 mm/minute; Kₛ determined between 25 and 75 N data points per Equation 1 in JIS K 6385:2012; K_{d} measured using deflection wave non-resonance method; data was collected at two dynamic strain amplitudes (0.2 and 2.0%); data was collected at two frequencies (15 and 100 Hz); data collected at 15 Hz was reported; tests were performed at 60° C.; and test specimen geometry was a cylinder measuring 17 mm in diameter and 25 mm in height. An illustration of the measurement of spring rate is provided in FIG. 1, wherein the Shape factor, S, is determined by L/4d, wherein L is the 25 mm height, d is the 17 mm diameter, and thus, S is 0.17. E_{c} is defined as 3G(1+2S²). E_{c} is thus approximately equal to 3G. Samples are subjected to analysis, as illustrated in FIG. 2, wherein K_{d} is determined by Fourier transform viscoelastic analysis from data collected at 23° C. at 60 Hz and at 0.1% dynamic strain (SSA), Kₛ is determined by linear regression of the final quasi-static loading segment in the range of 80 to 100 N, and wherein K_{d}/Kₛ is at 23° C. at 0.1% dynamic strain at 60 Hz. Static loading is 0.05 N/min, 100 N (0.4 MPa). Dynamic loading is a strain sweep (log)+/− from 0.1 to 2.5% strain, 1 Hz, 10 Hz, and 60 Hz. FIGS. 2A and 2B illustrate the load and test conditions for spring rate measurement and the extraction of data for the same.

As briefly described above, conventional vibration isolation devices utilizes rubber compounds comprising a blend of thermal carbon blacks and furnace carbon blacks to achieve desirable hysteresis and mechanical properties. In various aspects, the present disclosure provides a carbon black having a specialized balance of colloidal properties, for example, surface area and structure, beyond those described in ASTM D1765. The present disclosure also provides rubber compounds and vibration isolation devices comprising these specialized carbon blacks.

TABLE 2
Rubber Data for Bushing Compounds

| | Units | N330 | Test A | Test B |
|---|---|---|---|---|
| Dispersion via IFM | | 96.9 | 98 | 98.5 |
| Mooney Viscosity | Min | 54.5 | 60.5 | 58 |
| Mooney Scorch T₅ | Min | 8.84 | 9.12 | 9.48 |
| Shore A Hardness | | 64 | 63.1 | 62.6 |
| 100% Modulus | MPa | 2.3 | 2.76 | 2.63 |
| 200% Modulus | MPa | 6.04 | 7.34 | 6.79 |
| 300% Modulus | MPa | 10.55 | 12.27 | 11.5 |
| Tensile Strength | MPa | 25.2 | 25.9 | 25.7 |
| Elongation | % | 572 | 552 | 561 |
| Rebound Resilience | % | 45.9 | 50.7 | 53.5 |
| Spring Rate (K_{d}/Kₛ) | — | 3.76 | 3.43 | 3.21 |
| Fatigue Life* | Kcycles | 36.1 | 37.2 | 35.8 |

*fatigue life is the Weibull characteristic life of tensile strips fatigued to failure at 100% strain

Replacement of a conventional carbon black with the inventive carbon black described herein, in a rubber bushing compound, can, in various aspects, provide one or more of equivalent static properties, similar or improved fatigue performance, a reduction in spring rate, and the flexibility to compound for optimizing the balance of rubber properties.

In one aspect, the present invention comprises an uncured rubber formulation, containing the inventive carbon black. In another aspect, the present invention comprises a cured rubber compound containing the inventive carbon black. In yet another aspect, the present invention comprises a rubber article for use in a bushing, wherein the rubber article comprises the inventive carbon black. In yet another aspect, the present invention comprises a bushing, wherein the bushing comprises a rubber article comprising the inventive carbon black.

### Automotive Engine Mount Compounds

Materials for use in automotive engine mount compounds should, in various aspects, have a minimized spring rate (i.e., K_{d}/Kₛ) to provide optimum vibration isolation performance, coupled with acceptable fatigue life and compound durability.

Conventional materials used in automotive engine mounts utilize N990 grade thermal carbon black in a natural rubber (NR) formulation to achieve a low spring rate. Since the large aggregate size and low surface area of N990 carbon has the potential to adversely affect the compound's durability and fatigue life, the N990 thermal black is typically blended with a furnace carbon black, such as a carcass grade carbon black (e.g., N700, N600, or N500 series furnace carbon black) to provide some static stiffness and compound durability/fatigue life. N990 thermal black is also significantly more expensive than furnace carbon blacks.

In one aspect, substitution of all or a portion of the N990 thermal black, or of the carbon black blend if a blend is used, with a low surface area and low structure product can provide improved performance at a reduced cost.

In Table 3, below, properties for conventional carbon blacks used in engine mount applications are compared to properties for inventive carbon blacks.

TABLE 3
Carbon Blacks for Automotive Engine Mount Applications

| | Conventional Carbon | | Inventive Carbon Blacks | | |
|---|---|---|---|---|---|
| | | N660 | Inv. | Inv. | Inv. |
| | N990 | (e.g.) | CB2 | CB3 | CB4 |
| OAN (ml/100 g) | 38 | 90 | 45 | 95 | 127 |
| COAN (ml/100 g) | 37 | 74 | 45 | 68 | 80 |
| NSA (m²/g) | 8 | 35 | 25 | 25 | 28 |
| STSA (m²/g) | 8 | 34 | 25 | 25 | 27 |
| Iodine (mg/g) | — | 36 | 25 | 20 | 30 |

In one aspect, the inventive carbon black comprises a furnace carbon black having an OAN of from about 25 ml/100 g to about 65 ml/100 g, from about 30 ml/100 g to about 60 ml/100 g, from about 35 ml/100 g to about 55 ml/100 g, from about 40 ml/100 g to about 50 ml/100 g, or from about 42 ml/100 g to about 48 ml/100 g. In various aspects, the carbon black has an OAN of about 40, 41, 42, 43, 44, 45, 46, 47, 48, 49, or 50 ml/100 g.

In another aspect, the inventive carbon black comprises a furnace carbon black having an OAN of from about 75 ml/100 g to about 115 ml/100 g, from about 80 ml/100 g to about 110 ml/100 g, from about 85 ml/100 g to about 105 ml/100 g, from about 90 ml/100 g to about 100 ml/100 g, or from about 92 ml/100 g to about 98 ml/100 g. In various aspects, the carbon black has an OAN of about 90, 91, 92, 93, 94, 95, 96, 97, 98, 99, or 100 ml/100 g.

In yet another aspect, the inventive carbon black comprises a furnace carbon black having an OAN of from about 107 ml/100 g to about 147 ml/100 g, from about 112 ml/100 g to about 142 ml/100 g, from about 117 ml/100 g to about 137 ml/100 g, from about 122 ml/100 g to about 132 ml/100 g, or from about 124 ml/100 g to about 130 ml/100 g. In various aspects, the carbon black has an OAN of about 122, 123, 124, 125, 126, 127, 128, 129, or 130 ml/100 g.

In one aspect, the inventive carbon black has a COAN of from about 25 ml/100 g to about 65 ml/100 g, or from about 30 ml/100 g to about 60 ml/100 g, from about 35 ml/100 g to about 55 ml/100 g, from about 40 ml/100 g to about 50 ml/100 g, or from about 42 ml/100 g to about 48 ml/100 g. In various aspects, the carbon black has a COAN of about 40, 41, 42, 43, 44, 45, 46, 47, 48, 49, or 50 ml/100 g.

In another aspect, the inventive carbon black has a COAN of from about 48 ml/100 g to about 88 ml/100 g, or from about 53 ml/100 g to about 83 ml/100 g, from about 58 ml/100 g to about 78 ml/100 g, from about 63 ml/100 g to about 73 ml/100 g, or from about 65 ml/100 g to about 71 ml/100 g. In various aspects, the carbon black has a COAN of about 63, 64, 65, 66, 67, 68, 69, 70, 71, 72, or 73 ml/100 g.

In yet another aspect, the inventive carbon black has a COAN of from about 60 ml/100 g to about 100 ml/100 g, or from about 65 ml/100 g to about 95 ml/100 g, from about 70 ml/100 g to about 90 ml/100 g, from about 75 ml/100 g to about 85 ml/100 g, or from about 77 ml/100 g to about 83 ml/100 g. In various aspects, the carbon black has a COAN of about 75, 76, 77, 78, 79, 80, 81, 82, 83, 84, or 85 ml/100 g.

In one aspect, the inventive carbon black has an NSA of from about 15 m²/g to about 35 m²/g, from about 20 m²/g to about 30 m²/g, or from about 22 m²/g to about 28 m²/g. In various aspects, the carbon black has an NSA of about 20, 21, 22, 23, 24, 25, 26, 27, 28, 29, or 30 m²/g.

In another aspect, the inventive carbon black has an NSA of from about 15 m²/g to about 35 m²/g, from about 20 m²/g to about 30 m²/g, or from about 22 m²/g to about 28 m²/g. In various aspects, the carbon black has an NSA of about 20, 21, 22, 23, 24, 25, 26, 27, 28, 29, or 30 m²/g.

In yet another aspect, the inventive carbon black has an NSA of from about 18 m²/g to about 38 m²/g, or from about 23 m²/g to about 33 m²/g, or from about 25 m²/g to about 31 m²/g. In various aspects, the carbon black has an NSA of about 23, 24, 25, 26, 27, 28, 29, 30, 31, 32, or 33 m²/g.

In one aspect, the inventive carbon black has an STSA of from about 15 m²/g to about 35 m²/g, from about 20 m²/g to about 30 m²/g, or from about 22 m²/g to about 28 m²/g. In various aspects, the carbon black has an STSA of about 20, 21, 22, 23, 24, 25, 26, 27, 28, 29, or 30 m²/g.

In another aspect, the inventive carbon black has an STSA of from about 15 m²/g to about 35 m²/g, from about 20 m²/g to about 30 m²/g, or from about 22 m²/g to about 28 m²/g. In various aspects, the carbon black has an STSA of about 20, 21, 22, 23, 24, 25, 26, 27, 28, 29, or 30 m²/g.

In yet another aspect, the inventive carbon black has an STSA of from about 17 m²/g to about 37 m²/g, or from about 22 m²/g to about 32 m²/g, or from about 24 m²/g to about 30 m²/g. In various aspects, the carbon black has an STSA of about 22, 23, 24, 25, 26, 27, 28, 29, 30, 31, or 32 m²/g.

In one aspect, the inventive carbon black has an Iodine number of from about 15 mg/g to about 35 mg/g, or from about 20 mg/g to about 30 mg/g, or from about 22 mg/g to about 28 mg/g. In various aspects, the carbon black has an Iodine number of about 20, 21, 22, 23, 24, 25, 26, 27, 28, 29, or 30 mg/g.

In another aspect, the inventive carbon black has an Iodine number of from about 10 mg/g to about 30 mg/g, or from about 15 mg/g to about 25 mg/g, or from about 17 mg/g to about 23 mg/g. In various aspects, the carbon black has an Iodine number of about 15, 16, 17, 18, 19, 20, 21, 22, 23, 24, or 25 mg/g.

In yet another aspect, the inventive carbon black has an Iodine number of from about 20 mg/g to about 40 mg/g, or from about 25 mg/g to about 35 mg/g, or from about 27 mg/g to about 33 mg/g. In various aspects, the carbon black has an Iodine number of about 25, 26, 27, 28, 29, 30, 31, 32, 33, 34, or 35 mg/g.

In one aspect, the inventive carbon black has an NSA of from about 15 to about 30 m2/g, or from about 20 to about 30 m²/g, and an OAN of from about 35 to about 135 ml/100 g, from about 40 to about 130 ml/100 g, from about 35 to about 105 ml/100 g, from about 85 to about 130 ml/100 g, or from about 45 to about 127 ml/100 g.

In one aspect, the inventive carbon black has one or more of an OAN of from about 35 ml/100 g to about 55 ml/100 g, from about 40 ml/100 g to about 50 ml/100 g, or from about 42 ml/100 g to about 48 ml/100 g, a COAN of from about 35 ml/100 g to about 55 ml/100 g, from about 40 ml/100 g to about 50 ml/100 g, or from about 65 ml/100 g to about 71 ml/100 g, a NSA of from about 15 m²/g to about 35 m²/g, from about 20 m²/g to about 30 m²/g, or from about 22 m²/g to about 28 m²/g, a STSA of from about 15 m²/g to about 35 m²/g, from about 20 m²/g to about 30 m²/g, or from about 22 m²/g to about 28 m²/g, and an Iodine number of from about 15 mg/g to about 35 mg/g, from about 20 mg/g to about 30 mg/g, or from about 22 mg/g to about 28 mg/g. In other aspects, the inventive carbon black has two or more, three or more, four or more, or all of the properties detailed above.

In another aspect, the inventive carbon black has one or more of an OAN of from about 85 ml/100 g to about 105 ml/100 g, from about 90 ml/100 g to about 100 ml/100 g, or from about 92 ml/100 g to about 98 ml/100 g, a COAN of from about 58 ml/100 g to about 78 ml/100 g, from about 63 ml/100 g to about 73 ml/100 g, or from about 65 ml/100 g to about 71 ml/100 g, a NSA of from about 15 m²/g to about 35 m²/g, from about 20 m²/g to about 30 m²/g, or from about 22 m²/g to about 28 m²/g, a STSA of from about 15 m²/g to about 35 m²/g, from about 20 m²/g to about 30 m²/g, or from about 22 m²/g to about 28 m²/g, and an Iodine number of from about 10 mg/g to about 30 mg/g, from about 15 to about 25 mg/g, or from about 17 mg/g to about 23 mg/g. In other aspects, the inventive carbon black has two or more, three or more, four or more, or all of the properties detailed above.

In yet another aspect, the inventive carbon black has one or more of an OAN of from about 117 ml/100 g to about 137 ml/100 g, from about 122 ml/100 g to about 132 ml/100 g, or from about 124 ml/100 g to about 130 ml/100 g, a COAN of from about 70 ml/100 g to about 90 ml/100 g, from about 75 ml/100 g to about 85 ml/100 g, or from about 77 ml/100 g to about 83 ml/100 g, a NSA of from about 18 m²/g to about 38 m²/g, from about 23 m²/g to about 33 m²/g, or from about 25 m²/g to about 31 m²/g, a STSA of from about 17 m²/g to about 37 m²/g, from about 22 m²/g to about 32 m²/g, or from about 24 m²/g to about 30 m²/g, and an Iodine number of from about 20 mg/g to about 40 mg/g, from about 25 mg/g to about 35 mg/g, or from about 27 mg/g to about 33 mg/g. In other aspects, the inventive carbon black has two or more, three or more, four or more, or all of the properties detailed above.

In a specific aspect, the carbon black has an OAN of about 45 ml/100 g, a COAN of about 45 ml/100 g, an NSA of about 25 m²/g, an STSA of about 25 m²/g, and an Iodine number of about 25 mg/g. In another specific aspect, the carbon black has an OAN of about 95 ml/100 g, a COAN of about 68 ml/100 g, an NSA of about 25 m²/g, an STSA of about 25 m²/g, and an Iodine number of about 20 mg/g. In another specific aspect, the carbon black has an OAN of about 127 ml/100 g, a COAN of about 80 ml/100 g, an NSA of about 28 m²/g, an STSA of about 27 m²/g, and an Iodine number of about 30 mg/g. Such carbon blacks can be utilized as a replacement for all or part of any conventional carbon black or blend used in an engine mount compound.

The distribution of aggregate sizes in a carbon black sample can be measured by disc centrifuge photosedimentometry (DCP). Conventional blends of carbon black used in vibration isolation applications produce a bi-modal distribution. In one aspect, the use of the inventive carbon blacks can provide a log-normal distribution of aggregate size and can provide a significant reduction in larger diameter aggregates within a compound, than a comparative blend of carbon black materials.

It should be noted that if an inventive grade of carbon black is used to replace all or a portion of a conventional carbon black or a blend of carbon blacks in an anti-vibration compound, the loading of the selected carbon black may need to be adjusted to account for differences in the colloidal properties of the carbon black. In one aspect, the loading can be adjusted to maintain equal compound hardness. One of skill in the art could make any adjustments for a particular rubber compound. In an exemplary aspect, where a conventional carbon black having a COAN of 74 ml/100 g and an STSA of 34 m²/g is replaced with an inventive carbon black having a COAN of 80 ml/100 g and an STSA of 28 m²/g, the loading of the respective carbon blacks can be adjusted from about 15 phr to about 14.4 phr.

Various exemplary rubber compound formulations are illustrated in Table 4, below, using a conventional blend of thermal and furnace carbon blacks, and using the inventive carbon blacks described herein. It should be understood that the present invention is not intended to be limited to NR compositions and can include all elastomers and blends thereof that are conventionally used in anti-vibration or other carbon black filled rubber compositions, such as, for example, NR, BR, SBR, NR/BR blends, nitrile rubbers, and blends thereof. In another aspect, the formulations can also have various ratios of other components, such as sulphur, accelerators, anti-oxidants, extenders, etc. The control formulation utilizes a conventional blend of N990 thermal carbon black and N660 furnace carbon black. Formulations EM-1, EM-2, and EM-3 comprise Inventive Carbon Black 2, 3, and 4, respectively.

TABLE 4
Engine Mount Formulations

| | | | |
|---|---|---|---|
| Control | EM-1 | EM-2 | EM-3 |

Loading (phr)

| | | | | |
|---|---|---|---|---|
| NR (SMR CV60) | 100 | 100 | 100 | 100 |
| Zinc Oxide | 5 | 5 | 5 | 5 |
| Stearic Acid | 2 | 2 | 2 | 2 |
| N990 Thermal CB | 45 | 0 | 0 | 0 |
| N660 Furnace CB | 15 | 0 | 0 | 0 |
| Inv. CB2 | 0 | 56.5 | 0 | 0 |
| Inv. CB3 | 0 | 0 | 42.6 | 0 |
| Inv. CB4 | 0 | 0 | 0 | 37.4 |
| TDAE Oil | 5 | 5 | 5 | 5 |
| 6PPD | 3 | 3 | 3 | 3 |
| Anti-ozonant wax | 2 | 2 | 2 | 2 |
| OBS | 2.1 | 2.1 | 2.1 | 2.1 |
| Sulphur | 0.25 | 0.25 | 0.25 | 0.25 |
| TMTD | 1 | 1 | 1 | 1 |

Testing data for the compounds referenced above is detailed below, in Table 5. Test methods refer to ASTM methods or to those commonly used in the carbon black and rubber industries.

TABLE 5
Engine Mount Compound Test Data

| | Units | Control | EM-1 | EM-2 | EM-3 |
|---|---|---|---|---|---|
| Dispersion via IFM | | 98 | 97.2 | 94 | 97.6 |
| Mooney Viscosity | Min | 35.2 | 28.2 | 42.3 | 43.5 |
| Mooney Scorch T₅ | Min | 12.8 | 11.7 | 13.7 | 13.7 |
| Shore A Hardness | | 52.3 | 52.4 | 52.1 | 53.3 |
| 100% Modulus | MPa | 1.61 | 1.41 | 1.62 | 1.67 |
| 200% Modulus | MPa | 3.93 | 3.23 | 4.06 | 4.22 |
| 300% Modulus | MPa | 7.28 | 6.1 | 7.44 | 7.66 |
| Tensile Strength | MPa | 22.1 | 24 | 23.2 | 23.7 |
| Elongation | % | 576 | 631 | 590 | 577 |
| Tearing Energy, T_{c} | kJ/m² | 32.6 | 53.0 | 35.2 | 29.8 |
| Spring Rate (K_{d}/Kₛ)¹ | — | 1.61 | 1.66 | 1.58 | 1.63 |
| Spring Rate (K_{d}/Kₛ)² | — | 1.42 | 1.46 | 1.41 | 1.41 |

¹Spring Rate at 60° C., with dynamic strain amplitude = 0.2%
²Spring Rate at 60° C., with dynamic strain amplitude = 2.0%
** Each spring rate data point is the average from two separate compound mixes

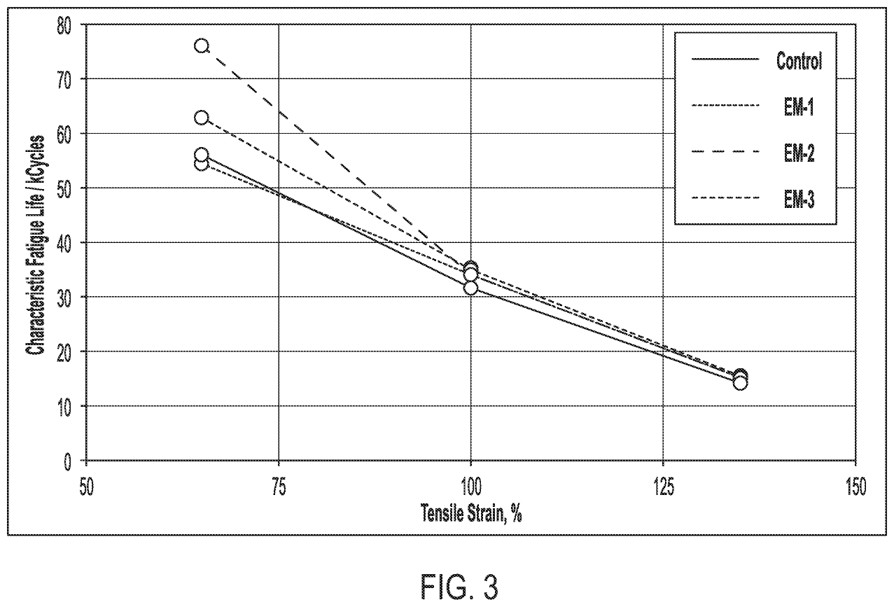

The fatigue life vs. tensile strain of the compounds listed in Table 5 are illustrated in FIG. 3, wherein the fatigue life is defined as the Weibull characteristic life of tensile strips fatigued to failure at 65, 100 and 135% strain per ASTM D4482.

It should be noted that dispersion of furnace carbon black materials can significantly impact fatigue life and spring rate values. In the samples detailed above, the data represent initial formulations, and it is believed that fatigue life and/or spring rate can be significantly improved by improving the dispersion of these materials.

In one aspect, the inventive carbon black materials, when used in vibration isolation devices, can impart similar or improved fatigue life, as compared to conventional blends of thermal carbon blacks and furnace carbon blacks. In another aspect, the use of inventive carbon black materials can simplify manufacturing and processing by eliminating the need to add and/or disperse secondary materials. In yet another aspect, the use of inventive carbon black materials can also result in lower compound cost, compared to the use of conventional blends. In addition, the use of the inventive carbon black materials described herein can result in significantly improved fatigue life at lower strains and tearing energies, important factors for engine mount applications.

In one aspect, hardness of the prepared compounds can be matched vs a control sample by adjusting the loading of the respective carbon blacks in the compound. For the inventive carbon blacks, tearing energy values are comparable or improved versus the control compound. Both EM-2 and EM-3 compounds show broadly equivalent K_{d}/Kₛ values vs the control compound.

As described above, the fatigue life of anti-vibration rubber compounds comprising the inventive carbon blacks can be improved vs conventional compounds. In particular, compounds utilizing Inventive Carbon Blacks 2 and 3 can exhibit significantly improved fatigue life at the low strains and tearing energies typical of engine mount applications.

In one aspect, Shore A Hardness and stress-strain properties of rubber compounds comprising the inventive carbon blacks are comparable or better than conventional vibration isolation compounds comprising a blend of thermal carbon black and furnace carbon black. In another aspect, the tensile strength of rubber compounds comprising the inventive carbon black are better than that in conventional vibration isolation compounds. In yet another aspect, critical tear energies (i.e., tear strength) of compounds comprising the inventive carbon blacks, as measured by ASTM D624, have at least equivalent or better tear energy, as compared to conventional vibration isolation compounds. In yet another aspect, rubber compounds comprising the inventive carbon blacks have spring rates that can provide equivalent or improved vibration isolation performance, as compared to conventional vibration isolation compounds.

Similarly, rubber compounds comprising the inventive carbon blacks exhibited fatigue life at three different strains, at least equivalent or better than that for conventional vibration isolation compounds.

In one aspect, Inventive Carbon Black 2 (Inv. CB2) can be used to replace a conventional blend of thermal carbon black and furnace carbon black, while providing equivalent static properties, equivalent or enhanced dynamic properties (isolation performance), equivalent or enhanced tear strength, enhanced tensile strength, enhanced fatigue life, and reduced cost.

Also as described above, use of an inventive carbon black in an anti-vibration compound can provide a significant cost savings over the use of a conventional carbon black or blend.

In one aspect, use of an inventive carbon black can provide similar or improved performance, such as, for example, durability, fatigue life, and/or vibration reduction, without sacrificing compound strength. In another aspect, the hardness values of compounds prepared using the inventive carbon blacks are equivalent to those of the control/reference material. In another aspect, an anti-vibration rubber compound can exhibit improved tensile strength and elongation, compared to a conventional material. In yet another aspect, dynamic data for compounds prepared using Inventive Carbon Blacks 2 and 3 are equivalent to the control material (a conventional compound). In another aspect, fatigue life measurements for compounds containing Inventive Carbon Blacks 2 and 3 illustrate that the dynamic properties of a compound can be maintained while simultaneously improving fatigue life at low tearing energies. In one aspect, and not wishing to be bound by theory, the improvement in fatigue life for anti-vibration rubber compounds comprising an inventive carbon black are due, at least in part, to the replacement of a bi-modal aggregate size distribution with a single grade of carbon black having a typical log-normal distribution.

In one aspect, the present invention comprises an uncured rubber formulation, containing the inventive carbon black. In another aspect, the present invention comprises a cured rubber compound containing the inventive carbon black. In yet another aspect, the present invention comprises a rubber article for use in an engine mount, wherein the rubber article comprises the inventive carbon black. In yet another aspect, the present invention comprises an engine mount, wherein the engine mount comprises a rubber article comprising the inventive carbon black.

It should be understood that any reference to a particular Inventive Carbon Black can also be intended to refer to any other Inventive Carbon Black. In one aspect, a rubber compound and/or a vibration isolation comprises only a single grade of carbon black (i.e., not a blend). In yet another aspect, a rubber compound comprises a furnace carbon black and does not comprise a thermal carbon black. In other aspects, the present disclosure is intended to disclose rubber compounds, components of vibration isolation devices, and vibration isolation devices containing the inventive carbon blacks described herein. In one aspect, any of the above rubber compounds, components, or vibration isolation devices can be a bushing, an engine mount, or other vibration isolation device.

### ASPECTS

In view of the described catalyst and catalyst compositions and methods and variations thereof, herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein.

Aspect 1: A rubber compound comprising a furnace carbon black having a nitrogen surface area of from about 15 m²/g to about 30 m²/g, and an oil absorption number of from about 35 ml/100 g to about 135 ml/100 g.

Aspect 2: The rubber compound of aspect 1, wherein the nitrogen surface area is from about 20 m²/g to about 30 m²/g.

Aspect 3: The rubber compound of aspects 1 or 2, wherein the oil absorption number is from about 45 ml/100 g to about 121 ml/100 g.

Aspect 4: The rubber compound of aspects 1 or 2, wherein the oil absorption number is from about 40 ml/100 g to about 130 ml/100 g.

Aspect 5: The rubber compound of any one of aspects 1-4, wherein the furnace carbon black has a compressed oil absorption number of from about 40 ml/100 g to about 90 ml/100 g.

Aspect 6: The rubber compound of any one of aspects 1-5, wherein the furnace carbon black has a statistical thickness surface area of from about 20 m²/g to about 32 m²/g.

Aspect 7: The rubber compound of any one of aspects 1-6, wherein the furnace carbon black has an iodine number of from about 15 mg/g to about 35 mg/g.

Aspect 8: The rubber compound of any one of aspects 1-7, wherein the furnace carbon black has an iodine number of from about 20 mg/g to about 30 mg/g.

Aspect 9: The rubber compound of any one of aspects 1-8, not comprising a thermal carbon black.

Aspect 10: The rubber compound of any one of aspects 1-9, being part of a vibration isolation device.

Aspect 11: A vibration isolation device comprising the rubber compound of any one of aspects 1-10.

Aspect 12: The vibration isolation device of aspect 11, comprising a furnace carbon black having a nitrogen surface area of from about 20 m²/g to about 30 m²/g, an oil absorption number of from about 40 ml/100 g to about 50 ml/100 g, a compressed oil absorption number of from about 40 ml/100 g to about 50 ml/100 g, a statistical thickness surface area of from about 20 m²/g to about 30 m²/g, and an iodine number of from about 20 mg/g to about 30 mg/g.

Aspect 13: The vibration isolation device of aspect 11, comprising a furnace carbon black having a nitrogen surface area of from about 20 m²/g to about 30 m²/g, an oil absorption number of from about 90 ml/100 g to about 100 ml/100 g, a compressed oil absorption number of from about 53 ml/100 g to about 63 ml/100 g, a statistical thickness surface area of from about 20 m²/g to about 30 m²/g, and an iodine number of from about 15 mg/g to about 25 mg/g.

Aspect 14: The vibration isolation device of aspect 11, comprising a furnace carbon black having a nitrogen surface area of from about 23 m²/g to about 33 m²/g, an oil absorption number of from about 122 ml/100 g to about 132 ml/100 g, a compressed oil absorption number of from about 75 ml/100 g to about 85 ml/100 g, a statistical thickness surface area of from about 22 m²/g to about 32 m²/g, and an iodine number of from about 25 mg/g to about 35 mg/g.

Aspect 15: The vibration isolation device of any one of aspects 11-14, wherein the vibration isolation device is an engine mount.

Aspect 16: A rubber article comprising a furnace carbon black having a nitrogen surface area of from about 55 m²/g to about 65 m²/g, and an oil absorption number of from about 145 ml/100 g to about 165 ml/100 g.

Aspect 17: The rubber article of aspect 16, having a statistical thickness surface area of from about 55 ml/100 g to about 65 ml/100 g.

Aspect 18: The rubber article of aspects 16 or 17, having a compressed oil absorption number of from about 90 ml/100 g to about 110 ml/100 g.

Aspect 19: The rubber article of any one of aspects 16-18, having an iodine number of from about 55 to about 65 mg/g.

Aspect 20: A vibration isolation device comprising the rubber article of any one of aspects 16-19.

Aspect 21: The vibration isolation device of any one of aspects 16-20, being a bushing.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A rubber compound comprising a furnace carbon black having a nitrogen surface area of from about 15 m²/g to about 30 m²/g, and an oil absorption number of from about 35 ml/100 g to about 135 ml/100 g.

2. The rubber compound of claim 1, wherein the nitrogen surface area is from about 20 m²/g to about 30 m²/g.

3. The rubber compound of claim 1, wherein the oil absorption number is from about 45 ml/100 g to about 121 ml/100 g.

4. (canceled)

5. The rubber compound of claim 1, wherein the furnace carbon black has a compressed oil absorption number of from about 40 ml/100 g to about 90 ml/100 g.

6. The rubber compound of claim 1, wherein the furnace carbon black has a statistical thickness surface area of from about 20 m²/g to about 32 m²/g.

7. The rubber compound of claim 1, wherein the furnace carbon black has an iodine number of from about 15 mg/g to about 35 mg/g.

8. The rubber compound of claim 1, wherein the furnace carbon black has an iodine number of from about 20 mg/g to about 30 mg/g.

9. The rubber compound of claim 1, not comprising a thermal carbon black.

10. The rubber compound of claim 1, being part of a vibration isolation device.

11. A vibration isolation device comprising the rubber compound of claim 1.

12. The vibration isolation device of claim 11, comprising a furnace carbon black having a nitrogen surface area of from about 20 m²/g to about 30 m²/g, an oil absorption number of from about 40 ml/100 g to about 50 ml/100 g, a compressed oil absorption number of from about 40 ml/100 g to about 50 ml/100 g, a statistical thickness surface area of from about 20 m²/g to about 30 m²/g, and an iodine number of from about 20 mg/g to about 30 mg/g.

13. The vibration isolation device of claim 11, comprising a furnace carbon black having a nitrogen surface area of from about 20 m²/g to about 30 m²/g, an oil absorption number of from about 90 ml/100 g to about 100 ml/100 g, a compressed oil absorption number of from about 53 ml/100 g to about 63 ml/100 g, a statistical thickness surface area of from about 20 m²/g to about 30 m²/g, and an iodine number of from about 15 mg/g to about 25 mg/g.

14. The vibration isolation device of claim 11, comprising a furnace carbon black having a nitrogen surface area of from about 23 m²/g to about 33 m²/g, an oil absorption number of from about 122 ml/100 g to about 132 ml/100 g, a compressed oil absorption number of from about 75 ml/100 g to about 85 ml/100 g, a statistical thickness surface area of from about 22 m²/g to about 32 m²/g, and an iodine number of from about 25 mg/g to about 35 mg/g.

15. The vibration isolation device of claim 11, wherein the vibration isolation device is an engine mount.

16. A rubber article comprising a furnace carbon black having a nitrogen surface area of from about 55 m²/g to about 65 m²/g, and an oil absorption number of from about 145 ml/100 g to about 165 ml/100 g.

17. The rubber article of claim 16, having a statistical thickness surface area of from about 55 ml/100 g to about 65 ml/100 g.

18. The rubber article of claim 16, having a compressed oil absorption number of from about 90 ml/100 g to about 110 ml/100 g.

19. The rubber article of claim 16, having an iodine number of from about 55 to about 65 mg/g.

20. A vibration isolation device comprising the rubber article of claim 16.

21. The vibration isolation device of claim 16, being a bushing.
